(19) United States
(12) Patent Application Publication
(10) Pub. No.: US 2010/0200492 A1
(43) Pub. Date: Aug. 12, 2010

(54) ASSEMBLY PROCESS AND METHOD OF SEALING FOR FLUID FILTERS

(76) Inventor: Zafar Hussain, Perrysburg, OH (US)

Correspondence Address: HONEYWELL/CANTOR COLBURN;Patent Services, 101 Columbia Road, P.O. Box, Morristown, NJ, 07962-2245, US

(21) Appl. No.: 12/759,946

(22) Filed: Apr. 14, 2010

Related U.S. Application Data
(63) Continuation-in-part of application No. 12/261,265, filed on Oct. 30, 2008.

(51) Int. Cl. B01D 35/34; B29C 65/52; B32B 38/00

(52) U.S. Cl. 210/444; 210/443; 156/212

(57) ABSTRACT

A fluid filter for a fluid circulation system having a filter mount, the fluid filter having: a housing; a filter element disposed within the housing; a tapping plate secured to the housing, the tapping plate defining a fluid inlet path for fluid to be filtered by the filter element and a fluid outlet path for fluid filtered by the filter element; and wherein a first peripheral edge portion of the tapping plate is engaged by a distal end of the housing that is bent around the first peripheral edge portion of the tapping plate and a second peripheral edge portion of the tapping plate is secured to an inner surface of the housing by an adhesive disposed between the second peripheral edge portion of the tapping plate and the inner surface of the housing.

### CROSS REFERENCE TO RELATED APPLICATIONS

This application is a continuation-in-part of U.S. patent application Ser. No. 12/261,265, filed Oct. 30, 2008, the contents of which are incorporated herein by reference thereto.

### BACKGROUND

Fluid filters (e.g. oil filters) are commonly used in engine lubrication systems, hydraulic systems, and fuel systems to remove abrasive particles from the fluid being circulated. Most filters use a mechanical or ‘screening’ type of filtration, with a replaceable cartridge having a porous filter element therein, through which oil is repeatedly cycled to remove abrasive impurities such as small particles or dirt. “Dirty” fluid enters an oil filter under pressure, passes through the filter media where it is “cleaned,” and then is redistributed throughout the engine. This can prevent premature wear by ensuring that impurities will not circulate through the engine and reach the close fitting engine parts. Filtering also increases the usable life of the oil.

Most oil filter assemblies include a filtration mechanism (e.g. filter media) and a tapping plate for mounting or installing the filter onto a filter mount extending from an engine. The tapping plate is also secured to a housing, which in conjunction with the tapping plate surrounds the filter media.

Accordingly, it is desirable to provide a one-piece tapping plate that is fixedly secured to the housing such that it will not rotate with respect to the housing when the filter is assembled.

### SUMMARY

In one exemplary embodiment, a fluid filter for a fluid circulation system having a filter mount is provided, the fluid filter having: a housing; a filter element disposed within the housing; a tapping plate secured to the housing, the tapping plate defining a fluid inlet path for fluid to be filtered by the filter element and a fluid outlet path for fluid filtered by the filter element; and wherein a first peripheral edge portion of the tapping plate is engaged by a distal end of the housing that is bent around the first peripheral edge portion of the tapping plate and a second peripheral edge portion of the tapping plate is secured to an inner surface of the housing by an adhesive disposed between the second peripheral edge portion of the tapping plate and the inner surface of the housing.

In another exemplary embodiment, a method for securing a tapping plate to a housing of a fluid filter for a fluid circulation system having a filter mount is provided, the method having the steps of: disposing an adhesive along an inner periphery of an open end of a housing of the filter; inserting the tapping plate into the housing wherein an outer peripheral edge portion of an upward member of the tapping plate frictionally engages the inner surface of the open end of the housing and the adhesive is disposed between the inner surface of the housing and the outer peripheral edge portion of the upward member; and bending a distal edge portion of the housing around the upward member of the tapping plate such that the distal edge portion is secured to an inner peripheral surface of the upward member, the inner peripheral surface being opposite to the outer peripheral edge portion of the upward member, wherein both the adhesive and the distal edge portion secure the tapping plate to the housing.

### BREIF DESCRIPTION OF DRAWINGS

FIG. 1 is a side view of a filter assembly in accordance with an exemplary embodiment of the present invention;

FIG. 1A is an enlarged cross-sectional view of the a portion of the filter assembly illustrated in FIG. 1;

FIG. 2 is an exploded partial cross-sectional view of a filter assembly in accordance with an exemplary embodiment of the present invention;

FIG. 3 is a cross-sectional view of a filter assembly in accordance with an exemplary embodiment of the present invention; and

FIG. 3A is an enlarged cross-sectional view of a portion of the filter assembly illustrated in FIG. 3.

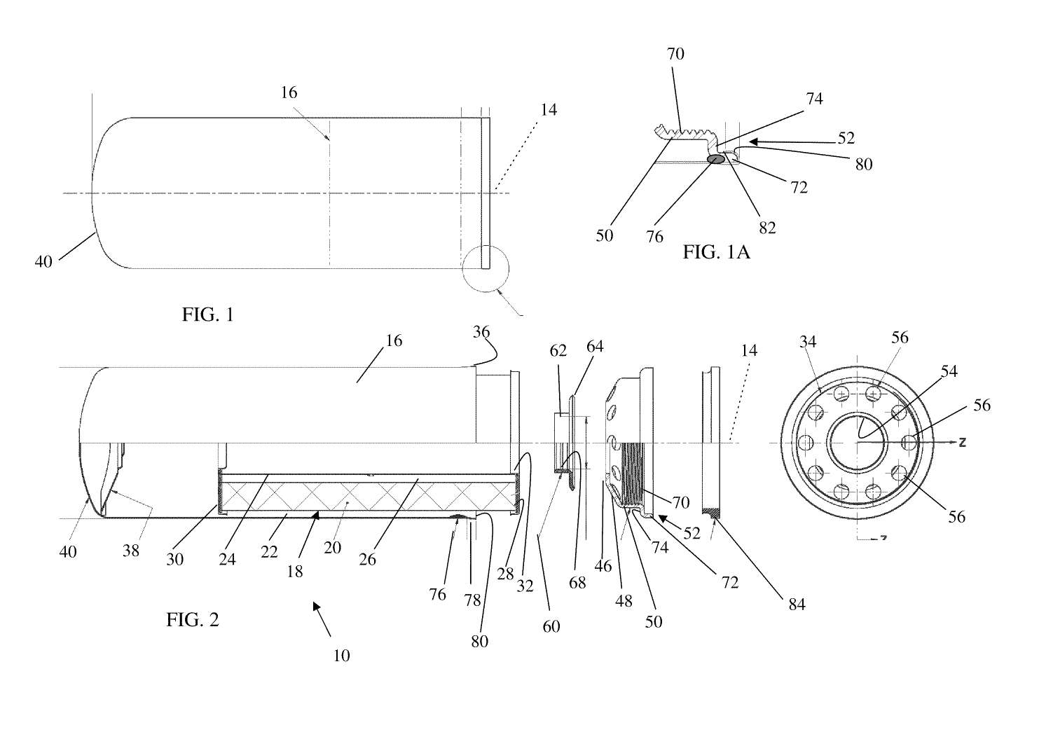

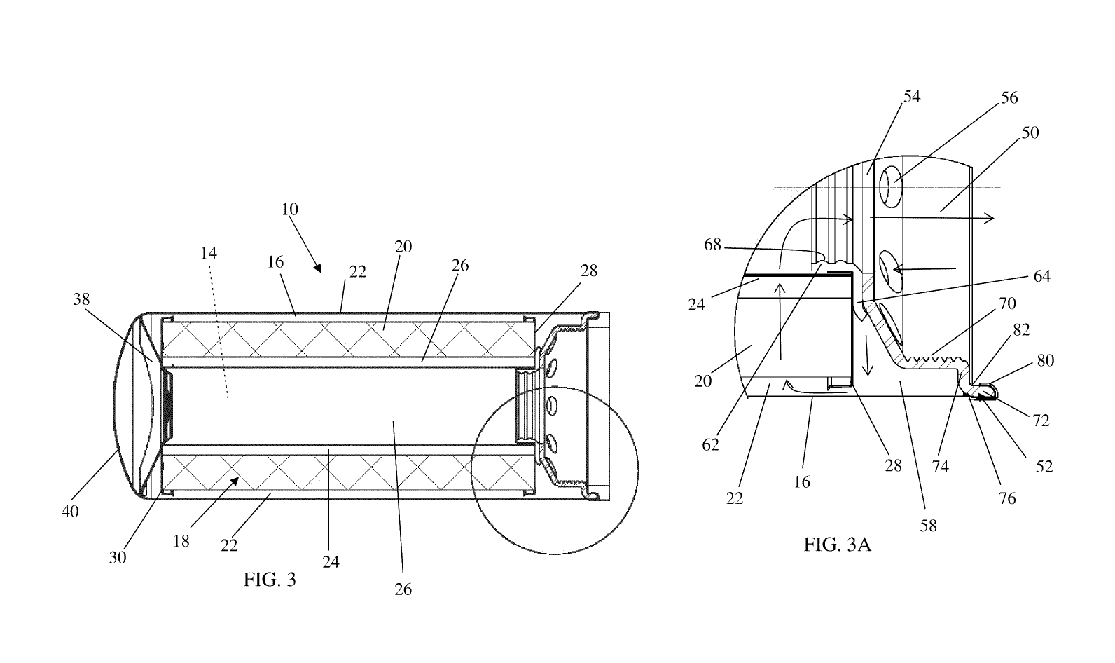

### DESCRIPTION OF EXEMPLARY EMBODIMENTS

Reference is made to the following patent publication U.S. 2009/0114580 the contents of which are incorporated herein by reference thereto.

Exemplary embodiments of the present invention are directed to a seal between the tapping plate and the filter housing. In one configuration, the tapping plate is configured to function as a tapping plate as well as a spacer between the tapping plate and an end disc of an oil filtration device (e.g., filter media) to create a passage for fluid flow with minimum restriction.

Exemplary embodiments of the present invention are directed to a two part seal of the tapping plate to the filter assembly wherein the one-piece tapping plate while the same is secured to the filter housing by a J-Seam or rolling process or equivalent securing process at one side of the tapping plate and an adhesive is used to secure the tapping plate to the housing at another side of the tapping plate.

Referring now to the FIGS., a filtering device or assembly 10 is shown according to an exemplary embodiment of the present invention. The filter assembly 10 is configured to be mounted onto a filter mount of an engine (not shown). More specifically, filter assembly 10 is adapted to be operably mounted to and in communication with a lubrication system, hydraulic system, fuel system, or other fluid circulation-type systems that benefit from fluid filtration provided by the assembly. Filter assembly 10 has an axial center 14 in which the filter components are reflected on both sides of the axial center.

As illustrated, filter assembly 10 includes a housing, frame, or can 16 surrounding a filtering element or member 18, which has a filtration media 20 configured to remove materials, such as dirt and abrasives, from a fluid (e.g., oil) being circulated through the filter assembly.

As illustrated, the filtering element is disposed within and supported by the housing as shown. A primary fluid path 22 is defined between housing 16 and filtering element 18 in which “dirty” or unfiltered fluid flows into the assembly in order to be filtered by the filtering element. In one non-limiting configuration, filtering element 18 has a cylindrical cross-sectional shape and includes an inner periphery and an outer periphery. Of course, other cross-sectional shapes are contemplated, such as oval, rectangular, oblong, etc.

As illustrated, the filter assembly 10 also includes a cylindrical core or sleeve, or center fuse 24 that is axially positioned within the inner periphery of the filtering element 18 and about axial center 14, thereby forming a hollow axial region in which a secondary fluid path 26 is defined such that “clean” or filtered fluid can flow therethrough and out of the assembly 10. In one implementation, cylindrical core 24 will have a plurality of apertures for filtered fluid to flow therethrough and into secondary fluid path 26. The number, diameter size, and configuration of apertures formed along the walls of cylindrical core 24 may vary depending on the needed filtering capacity and application. It is also understood that assembly 10 may also be manufactured without core 24 and the inner surface of the filter element will define the path 26.

The filter element will also have a first end disc 28 and a second end disc 30 each being secured to an opposite end of the filter element. The end discs are secured to the filtering element by any suitable means for securing such as, for example, a weld, a braze, a gasket, adhesives or any other known methods. Other conventional techniques for securing the end discs include but are not limited to epoxies, thermal bonding, or spin welding. The first end disc has an opening 32 aligned with the hollow axial region defined by the filtering element while the second end disc closes off the hollow axial region defined by the filter element such that secondary fluid path 26 exits out of opening 32.

Secured to the filter assembly is a one-piece tapping plate 34. Advantageously, the tapping plate is a one-piece design that functions both as a means for installing or mounting the filter assembly onto a filter mount extending from an engine or other device having fluids to be filtered as well as providing a spacer between the tapping plate and the first end disc. The one-piece tapping plate is also configured to create a passage for fluid flow therethrough with a minimum amount of restriction.

As illustrated, the tapping plate generally has a concave circular shape and is constructed out of a metal material, such as steel, iron or any other suitable material. During assembly of the filter assembly, the filter element is first inserted into an open end 36 of the housing until the second end disc contacts a spring member 38 secured to a bottom surface 40 of the housing. In order to align the spring member with the second end disc the second end disc is configured to have a feature or depression 42 to receive a protrusion 44 of spring member 38.

After insertion of the filter element into the housing the tapping plate is then inserted into the open end of the housing. The tapping plate has a bottom surface portion 46, an angled wall portion 48, a side wall portion 50 and a mounting portion 52. The bottom surface portion has an opening or central aperture 54 that is configured to align with the opening of first end disc. The tapping plate also has a plurality of openings or fluid inlet ports 56 disposed in the angled wall portion. The inlet ports are located about the central aperture 54, which is aligned with the axial center 14 when the tapping plate is secured to the filter assembly. The openings 56 are spaced apart and positioned generally around and adjacent to the central aperture as shown. The openings 56 provide fluid pathways for the “dirty” or unfiltered fluid to flow through and into the primary fluid path 22 and consequently through the media of the filtering element. The openings 56 are formed in the angled wall portion 48 and as illustrated the wall portion and the openings 56 are angularly offset from the planar surface of first end disc 28, thereby forming a space or gap 58 between the first end disc 28 and the plurality of openings 56 for fluid to flow through with a minimum amount of restriction. It should be understood that the number, diameter size, and configuration of openings 56 formed along wall portion 48 of the tapping plate could vary depending on the needed filtering capacity and application.

In order to provide a seal between the first end disc and the bottom surface portion of the tapping plate a grommet 60 is located between the first end disc and the bottom surface portion of the tapping plate. The grommet is formed from a rubber or other suitable material. The grommet also has a shaft portion 62 configured to be disposed in the central aperture of the filtering element and a disk portion 64 that is located between the first end disc portion and the bottom surface portion of the tapping plate. The grommet also provides a seal for the spud of a filter mount inserted into the filter assembly to provide the fluid outlet path.

For example the shaft portion of the grommet is configured to receive a spud of filter mount (not shown) that is in fluid communication with the secondary fluid path 26 such that an outlet path from the filter assembly is provided. See for example FIG. 2 of U.S. 2009/0114580 the contents of which are incorporated herein by reference thereto. Thus, fluid filtered the filtering element 18 can flow out of the filter assembly. As a result, a fluid path extends from fluid inlet ports 56, space 58, primary fluid path 22, through the media of filtering element 18 into secondary fluid path 26 and into an aperture 68 of the shaft portion of the grommet is created.

The inside surface of the wall portion of the tapping plate has a threaded portion 70 for correspondingly engaging or mating with a threaded wall portion of the filter mount. Accordingly and in order to secure the filter assembly to a fluid filtration assembly, the threaded portion of the tapping plate engages with the threaded wall portion of the filter mount as the assembly is spun around the threaded portion of the filter mount.

As illustrated, the tapping plate has a mounting portion 52 that has a generally L-shaped profile having with an upward member 72 to form an upward distal protrusion extending from the tapping plate. The L-shaped profile also has a shoulder portion 74.

In order to secure the tapping plate to the housing an adhesive 76 is disposed on an inner surface of the housing. The adhesive is located just below a flared portion 78 of the open end of the housing. The flared portion is configured to provide an interference fit between an outer surface of the upward member 72 of the tapping plate as it is inserted into the open end of the housing. As the tapping plate is inserted into the housing the outer surface of the upward member engages the inside surface of the housing and ultimately the adhesive 76 is disposed between the outer surface of the upward member 72 and the inner surface of the housing.

In one exemplary embodiment, the adhesive 76 is an anaerobic adhesive (e.g. an adhesive that remains in a liquid state until it is isolated from oxygen in the presence of metal ions, such as iron or copper). For example, when an anaerobic adhesive is sealed between two metal surfaces it rapidly “cures” or hardens to form a tough cross-linked plastic that will bond quite well to many metals. Of course, other types of adhesives may be used.

As the tapping plate is inserted into the housing until the bottom surface portion of the tapping plate engages the grommet to provide a seal between the first end disc and the tapping plate and the outer surface of the side wall portion engages the adhesive as well as an interference fit is provided between the tapping plate and the housing. To complete the securement of the tapping plate to the housing a distal end 80 of the housing at an open end of the housing is bent over and substantially around the periphery of the upward member 72 of the tapping plate after the tapping plate is inserted into the housing and positioned on top of the first end disc of the filter media in order to secure the tapping plate to the housing.

The distal end of the housing is bent over the upward member 72 extension member of the upper edge portion of the tapping plate such that a gap 82 is formed between the end of the distal end of the housing proximate to the shoulder portion 74 of the tapping plate, thus sending all axial loads through the housing as opposed to the first end disc of the filter element. The bending of the distal end of the housing over the upward member of the tapping plate also secures the grommet between the tapping plate and the first end disc. The process of bending the distal end of the housing over the upward member of the tapping plate is often referred to as a J-Seam process or rolling process. Thereafter an elastic seal or ring 84 is inserted into the mounting portion 52 of the tapping plate.

Accordingly, a two part seal is made between the housing and the tapping plate in order seal the tapping plate to the filter housing. Exemplary embodiments of the present invention are directed to a two part seal of the tapping plate to the filter assembly wherein the one-piece tapping plate is secured to the filter housing by a J-Seam or rolling process or equivalent securing process at one side of the tapping plate and an adhesive is used to secure the tapping plate to the housing at another side of the tapping plate.

By using this two-part sealing method the tapping plate will not rotate with respect to the housing as it is rotated and spun onto a threaded portion of the filter spud it is secured to. In one exemplary embodiment, the two part seal will withstand up to a minimum of 130 ft-lbs of torque without slipping with respect to the housing. Of course, the filter assembly can be configured to withstand torques greater or less than 130 ft-lbs of torque.

In accordance with exemplary embodiments of the present invention the filter assembly is assembled by inserting the tapping plate into the housing after the filter element and the tapping plate is sealed and locked to the housing. A flared body of the housing provides an interference fit and a sealing compound is used to provide a seal on one side of the tapping plate and then a J-Seam is used to seal on another side of the tapping plate. The interference fit between the body and tapping plate along with the usage of the compound keeps the tapping plate from slipping and leaking.

During assembly, the tapping plate is dropped into the body and is aligned and pushed further into the body with a J-Seam head and its integrated locator. A 1640 to 1690 lb load rolls the distal end of the body over the tapping plate end to make a lock seam of course, loads greater or less than the aforementioned ranges may used. The compound dispensed on the body creates a lock and seal between the body and the tapping plate at the outer surface of the tapping plate.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims and their legal equivalence.

What is claimed is:

1. A fluid filter for a fluid circulation system having a filter mount, the fluid filter comprising:
a housing;
a filter element disposed within the housing;
a tapping plate secured to the housing, the tapping plate defining a fluid inlet path for fluid to be filtered by the filter element and a fluid outlet path for fluid filtered by the filter element; and
wherein a first peripheral edge portion of an upward member of the tapping plate is engaged by a distal end of the housing that is bent around the first peripheral edge portion of the upward member and a second peripheral edge portion of the upward member opposite to the first peripheral edge portion is secured to an inner surface of the housing by an adhesive disposed between the second peripheral edge portion of the tapping plate and the inner surface of the housing.

2. The fluid filter as in claim 1, wherein the adhesive is an anaerobic adhesive.

3. The fluid filter as in claim 2, wherein the distal end of the housing has a flared opening that engages the tapping plate with an interference fit when it is inserted into the housing.

4. The fluid filter as in claim 1, wherein the upward member of the tapping plate comprises a portion of a mounting member of the tapping plate, the mounting member having a shoulder portion wherein the upward member and the shoulder portion define an “L” shape.

5. The fluid filter as in claim 4, wherein the distal end of the housing is spaced from the shoulder portion when the distal end is bent around the upward member of the tapping plate.

6. The fluid filter as in claim 4, wherein the tapping plate further comprises a threaded wall portion extending from the shoulder portion.

7. The fluid filter as in claim 6, wherein the tapping plate further comprises an angled wall portion extending from the threaded wall portion, the angled wall portion having a plurality of openings located therein.

8. The fluid filter as in claim 7, wherein the tapping plate further comprises a bottom surface portion extending from the angled wall portion, the bottom surface portion having a central opening aligned with an opening of a first disc portion secured to an end of the filter element, wherein the bottom surface portion is sealed to the first disc portion.

9. The fluid filter as in claim 8, wherein the bottom surface portion is sealed to the first disc portion by a rubber grommet

10. The fluid filter as in claim 9, wherein the adhesive is an anaerobic adhesive.

11. The fluid filter as in claim 10, wherein the distal end of the housing has a flared opening that engages the tapping plate with an interference fit when it is inserted into the housing.

12. The fluid filter as in claim 11, wherein the distal end of the housing is spaced from the shoulder portion when the distal end is bent around the upward member of the tapping plate.

13. The fluid filter as in claim 1, wherein the distal end of the housing has a flared opening that engages the tapping plate with an interference fit when it is inserted into the housing.

14. A method of securing a tapping plate to a housing of a fluid filter for a fluid circulation system having a filter mount, the method comprising:
disposing an adhesive along an inner periphery of an open end of a housing of the filter;
inserting the tapping plate into the housing wherein an outer peripheral edge portion of an upward member of the tapping plate frictionally engages the inner surface of the open end of the housing and the adhesive is disposed between the inner surface of the housing and the outer peripheral edge portion of the upward member; and
bending a distal edge portion of the housing around the upward member of the tapping plate such that the distal edge portion is secured to an inner peripheral surface of the upward member, the inner peripheral surface being opposite to the outer peripheral edge portion of the upward member, wherein both the adhesive and the distal edge portion secure the tapping plate to the housing.

15. The method as in claim 14, wherein the filter further comprises: a filter element disposed within the housing; and wherein the tapping plate defines a fluid inlet path for fluid to be filtered by the filter element and a fluid outlet path for fluid filtered by the filter element.

16. The method as in claim 14, wherein the adhesive is an anaerobic adhesive.

17. The method as in claim 16, wherein the distal end of the housing has a flared opening that engages the outer peripheral edge portion of the upward member of the tapping plate with an interference fit when it is inserted into the housing.

18. The method as in claim 14, wherein the upward member of the tapping plate comprises a portion of a mounting member of the tapping plate, the mounting member having a shoulder portion wherein the upward member and the shoulder portion define an “L” shape and wherein the distal end of the housing is spaced from the shoulder portion when the distal end is bent around the upward member of the tapping plate.

19. The method as in claim 18, wherein the tapping plate further comprises a threaded wall portion extending from the shoulder portion and an angled wall portion extending from the threaded wall portion, the angled wall portion having a plurality of openings located therein and a bottom surface portion extending from the angled wall portion, the bottom surface portion having a central opening aligned with an opening of a first disc portion secured to an end of the filter element, wherein the bottom surface portion is sealed to the first disc portion by a rubber grommet

20. The method as in claim 18, wherein the distal end of the housing is spaced from the shoulder portion when the distal end is bent around the upward member of the tapping plate.
